(19) United States
(12) Patent Application Publication
(10) Pub. No.: US 2004/0213492 A1
(43) Pub. Date: Oct. 28, 2004

(54) Composite bearings

(76) Inventors: Michael Kim, Marlton, NJ (US); Yuan Peng, Marlton, NJ (US); Michael Horchuck, Williamstown, NJ (US)

Correspondence Address: Todd W. Galinski, Kilpatrick Stockton LLP, 1001 West Fourth Street, Winston-Salem, NC, 27101, US

(21) Appl. No.: 10/829,771

(22) Filed: Apr. 22, 2004

Related U.S. Application Data
(60) Provisional application No. 60/464,842, filed on Apr. 23, 2003.

(51) Int. Cl. F16C 33/18; F16C 33/20; F16C 33/44

(52) U.S. Cl. 384/300

(57) ABSTRACT

Composite bearings and methods for manufacturing these bearings are provided in which a lining comprising polytetrafluoroethylene fiber and a second fiberous material are disposed within a polymeric matrix comprising polytetrafluoroethylene particles and a wetting agent. The composite bearings may be useful in hydropower applications where self-lubricating bearings containing graphite are undesirable because graphite can be corrosive to carbon steel.

### STATEMENT OF RELATED APPLICATION

The present application claims priority under 35 U.S.C. §119(e) from U.S. Provisional Application Ser. No. 60/464,842, filed Apr. 23, 2003, entitled “Self-Lubricating Filament Winding Composite Bearings,” the disclosure of which is incorporated herein by reference.

### FIELD OF THE INVENTION

This invention relates to composite bearings and methods of manufacture thereof.

### BACKGROUND OF THE INVENTION

Composite bearings can be used to provide low wear rates in a variety of high load applications. Composite bearings are currently available which feature a combination of a fibrous surface liner comprising a controlled filament wound pattern of both polytetrafluoroethylene (PTFE) and high strength fibers disposed within a thermosetting resin or other polymer. For example, it has been known to provide a thermosetting resin bearing with a lining containing PTFE strands and other polymeric fabrics, which together adhere to the resin and provide a low coefficient of friction for minimizing wear.

PTFE fibers disposed on a self-lubricating bearing surface can deteriorate as the temperature and fiber stresses increase during service. One attempt to overcome this deficiency has been to supplement the PTFE fibers with graphite fibers, graphite powders, and other materials to improve high temperature wear.

In certain applications, use of a self-lubricating bearing containing graphite is undesirable because graphite can be corrosive to materials used to fabricate shafts, such as carbon steel. For example, in hydropower applications, galvanic corrosion of a steel shaft should be avoided.

As a result, there is a need for self-lubricating bearings that may not include materials corrosive to carbon steel and that can perform similarly to graphite containing self-lubricating bearings in aspects such as, but not limited to, wear life and heat dissipation.

### SUMMARY OF THE INVENTION

The present invention provides composite bearings and methods for manufacturing composite bearings. The composite bearings comprise polytetrafluoroethylene (PTFE) particles and a wetting agent in combination with fibers of PTFE and a second fiberous material in a polymeric matrix.

The present invention also provides a method for manufacturing a composite bearing comprising: disposing a plurality of fibers comprising polytetrafluoroethylene and a resin-bondable material onto a mandrel, said fibers being disposed in a thermosetting resin comprising polytetrafluoroethylene particles and a wetting agent; and curing said thermosetting resin to form a rigid composite.

Accordingly, a composite bearing is provided that can be useful in applications where galvanic corrosion should be avoided. The composite bearings may perform similarly or better than graphite containing self-lubricating bearings in aspects such as, but not limited to, wear life and heat dissipation.

### BRIEF DESCRIPTION OF THE DRAWINGS

The accompanying drawings illustrate an embodiment of the invention.

FIG. 1 is a perspective illustration of an embodiment of a composite bearing of the present invention;

FIG. 2 is an enlarged detail of a side, cross-sectional view of the bearing of FIG. 1 taken through line 2-2.

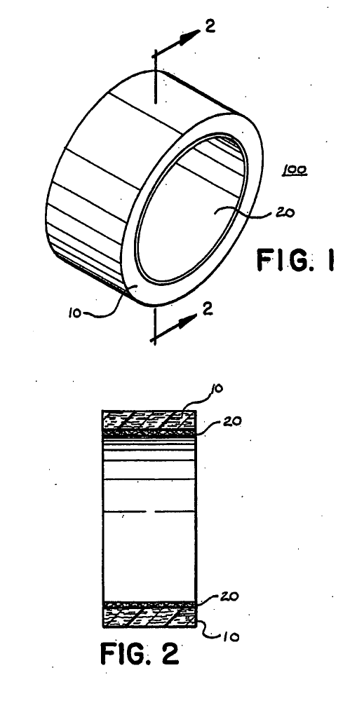

### DETAILED DESCRIPTION OF THE INVENTION

The composite bearings of this invention comprise: a supporting shell having a surface; and a lubricating lining disposed on said surface comprising fibers of polytetrafluoroethylene wound with a second fibrous material, said fibers being in a polymeric matrix comprising polytetrafluoroethylene particles and a wetting agent. The wetting agent is operable to reduce the surface energy of a resinous material and allow the resinous material to wet the PTFE particles such that the PTFE particles can be evenly dispersed throughout the resinous material used to prepare the polymer matrix. The wetted PTFE particles can reduce deterioration of fibers disposed within the polymer matrix of a bearing.

Referring now to the Figures, a composite bearing is illustrated. The composite bearing 100 comprises a support shell 10 having a surface thereon. Disposed on this surface is a lubricating lining 20 comprising fibers of polytetrafluoroethylene wound with a second fibrous material. In an embodiment, the lining may be self-lubricating. These fibers are disposed in a polymeric matrix comprising PTFE particles and a wetting agent.

The second fibrous material of this invention comprises any polymeric fiber material bondable to the polymeric matrix of the lining 20. A particular polymeric fiber material may be selected based on its cost, uniformity, or strength. In an embodiment, the second fibrous material may comprise a polymeric fiber that can be twisted together with the polytetrafluoroethylene fibers. Twisted polymeric fibers useful in the present invention may comprise resin-bondable yarn and may comprise polyester, nylon, aramid, or cellulosic material. In an embodiment, a resin-bondable yarn may comprise DACRON® polyester. In another embodiment, a resin-bondable yarn may comprise NOMEX® nylon.

The support shell 10 may comprise any material useful to prepare the rigid support shell 10. For example, the support shell 10 may comprise a suitable metal backing or housing and the lining 20 can be affixed to the support shell 10 through means of an adhesive. In embodiments useful for hydropower applications, the support shell 10 and polymeric matrix of the lining 20 of this invention may comprise a resinous material such as, but not limited to, any of the well-known thermosetting resins suitable for use in a bearing. Useful thermosetting resins may include those that have high strength and low shrinkage during curing. An example of a resinous material useful in the present invention is epoxy resin. In an embodiment, an epoxy resin may comprise a polyether resin formed originally by the polymerization of bisphenol A and epichlorohydrin. Further examples of potentially suitable materials for use to construct the support shell 10 and polymeric matrix of the lining 20 are glass/epoxy, glass/polyester, glass/phenolic, linen/phenolic and cotton/phenolic.

Two potentially useful categories of epoxy formulations, which are based upon their hardener reactive ingredients, include those reacted with various anhydrides or amines. In an embodiment, an epoxy resin of this invention may include about 1500 parts by weight EPON® 826 or 828 (Shell Chemical Co.), 1350 parts by weight hardener such as, but not limited to, methyl anhydride (Anhydrides & Chemical Co.) or NADIC® methyl anhydride (Buffalo Color Corp.), and 30 parts by weight of a curing accelerator such as, but not limited to, “BDMA” benzyl dimethyl amine accelerator DY062 (Ciba-Geigy Corp.).

Any PTFE particles may be used so long as the particles are have a total surface area sufficiently high to be wetted and can be evenly dispersed in the resinous material. In an embodiment, the particle size of 95% of the PTFE particles is less than 500 micro inches (ASTM D4895). In another embodiment, the particle size of 95% of the PTFE particles is greater than 200 micro inches (ASTM D4895). Examples of commercially available PTFE particles potentially useful in the invention include, but are not limited to, Teflon® 62 and 600A (Dupont); CD1 and CD014 (ICI); Hostaflon® TF-2053 and TF-2071 (Dyneon). The upper limit of the amount of PTFE may be determined by various factors such as, but not limited to, cost, the resulting viscosity of the resinous material, the compressive strength of the final composite material, and the ease with which the coated fibers are able to be wound. In an embodiment, the amount of PTFE particles in the polymer matrix is less than 15% by weight. In another embodiment, amount of PTFE particles in the polymer matrix is greater than 1% by weight. In another embodiment, the amount of PTFE particles in the polymer matrix is between 8 and 12% by weight.

In an embodiment, the PTFE particles can be mixed into one of the epoxy recipe ingredients to remove clusters. Ball mills, roller mills, and high shear mixers are well known equipment in the solids dispersion industry to accomplish this task.

Any wetting agent operable to reduce the surface energy of the resinous material used to prepare the polymer matrix may be used to wet the PTFE particles. Wetted PTFE particles may be more readily suspended and evenly distributed in the resinous material than PTFE particles that have not been wetted. Also, wetted PTFE particles may agglomerate at a lower rate than PTFE particles that have not been wetted. Even distribution of the wetted PTFE within the resinous material may improve quality control and the performance characteristics of the composite bearing. The particular wetting agent useful in the invention may depend upon the resinous material used to prepare the polymer matrix and its surface energy. Examples of potentially useful wetting agents include non-ionic wetting agents such as non-ionic siloxane copolymers such as TroySol™ S366 and S367 (Troy Chemical Corp.) and Silwet® L7600 (polydimethylsiloxane methylethoxylate, GE Silicones). Other useful non-ionic wetting agents may include Triton® X-100 and X-305 (Octylphenoxypolyethoxy ethanol, Dow Chemical). In an embodiment wherein the resinous material comprises an epoxy thermosetting resin, the wetting agent may comprise a non-ionic siloxane copolymer.

In an embodiment, the PTFE particles can be wetted by mixing at room temperature (25° C. or less) for 10 minutes a mixture comprising NADIC® methyl anhydride, PTFE particles, and TroySol™ S366 wetting agent. The mixture can be mixed with an industrial “Jiffy” or “Lightning Propeller Mixer”. The mixture is re-mixed after 24 hours for another 10 minutes at room temperature. The resulting dispersion can be used to wind a helical weave of PTFE and resin-bondable yarn of the liner wind.

In one embodiment of the method of the present invention, two-plies of polyester (DACRON®) or nylon (NOMEX®) and one-ply of PTFE fiber can be twisted together and helically wound over a chrome plated steel mandrel. In a further embodiment, the fibers are wound to an average wall thickness of about 0.01 to 1.0 inches (0.025 cm to 2.54 cm). In another embodiment, the fibers are wound to an average wall thickness of about 0.025 to 0.035 inches (0.063 cm to 0.089 cm). In another embodiment, prior to winding, the helically wound cord can be dipped into an epoxy resin comprising PTFE particles and a wetting agent, to saturate the fibers. In another embodiment, the bearings of this invention can be manufactured using such methods as pulling a knitted tube of fibers or wrapping a woven cloth of fibers over a mandrel prior to, or subsequent to, impregnation with an epoxy resin comprising PTFE powder and a wetting agent.

Certain of the benefits of this invention are exemplified by the following examples. Each example was tested on a Low Amplitude Oscillation (HOT) bearing test machine developed by Glacier Garlock Bearings, Inc. to test self-lubricating bearing wear life at conditions of median load, typically greater than 4,000 psi, and median speed, typically from about 3 feet/minute (91.4 cm/minute). The ±5° oscillating mode of shaft direction can simulate many of the commercial applications for the bearing products this machine tests, such as the pivot mechanism of a wicket gates on hydropower generators. The bearing load is applied to the fixed bearing, encased in a housing, through a weight loaded mechanical cantilever system. The shaft, supported on both sides beyond the test bearing, oscillates by a variable speed motor drive though the test bearing that is maintained at a constant load. Wear depth is measured by the bearing wall thickness changes at the middle point of contact area.

### EXAMPLES

### Example 1 Comparative

A PTFE-Dacron® filament wound composite bearing (1620-11 MLG bearing by GGB, Thorofare, N.J.) without PTFE particles or wetting agent was tested on a HOT testing machine with the following test conditions: pressure=4,300 psi, oscillation=10° total+/−5° from center, speed=200 cycles per minute and a steel shaft finish=7 micro-inches AA and surface hardness of about 100 to 120 Rockwell “B”. This test represented the “control” and was conducted over approximately a 90 hours period, resulting in a wear depth of 0.017 inches (0.043 cm) at 1.1 million cycles.

### Example 2

A bearing having the lining composition and construction of Example I, but including PTFE particles and wetting agent in the epoxy liner was subject to the same HOT test conditions, resulting in a wear depth of 0.007 inches (0.018 cm) at the end of test.

The PTFE particles were wetted in the following manner. A mixture comprising NADIC® methyl anhydride (8 kg), Teflon®#62 PTFE fine powder (2 kg), and TroySol™ S366 (0.2 kg) was mixed with an industrial “Jiffy” or “Lightning Propeller Mixer” for 10 minutes. The mixture was re-mixed after 24 hours for another 10 minutes. The resulting dispersion was mixed with Epon 828 epoxy (9 kg) and BDMA (0.2 kg) for 15 more minutes. A PTFE-Dacron® filament wound composite bearing having the lining composition and construction of Example 1, but including PTFE particles and wetting agent in the epoxy liner was manufactured to 1620-11 test bearings.

The bearings prepared according to Examples 1 and 2 were tested for their Low Amplitude Wear (4.3 ksi and 1.1 million cycles). The bearing from Example 1 (Comparative) had a Wear Factor (in/cycle)/(psi*fpm) of 2.5*10⁻¹³. The bearing from Example 2 containing PTFE particles had a Wear Factor (in/cycle)/(psi*fpm) of 1.0* 10⁻¹³

We claim:

1. A composite bearing comprising:
a supporting shell having a surface; and
a lubricating lining disposed on said surface comprising fibers of polytetrafluoroethylene wound with a second fibrous material, said fibers being in a polymeric matrix comprising polytetrafluorethylene particles and a wetting agent.

2. The composite bearing of claim 1, wherein 95% of the polytetrafluorethylene particles have a particle size of less than 500 micro inches.

3. The composite bearing of claim 1, wherein 95% of the polytetrafluorethylene particles have a particle size of greater than 200 micro inches.

4. The composite bearing of claim 1, wherein the polymer matrix comprises less than 15% by weight of polytetrafluoroethylene particles.

5. The composite bearing of claim 1, wherein the polymer matrix comprises greater than 1% by weight of polytetrafluoroethylene particles.

6. The composite bearing of claim 1, wherein the wetting agent comprises a non-ionic siloxane copolymer.

7. The composite bearing of claim 1, wherein said second fibrous material comprises a polymeric fiber twisted together with said polytetrafluoroethylene fibers.

8. The composite bearing of claim 7, wherein said polymeric fiber comprises a resin-bondable yarn.

9. The composite bearing of claim 7, wherein said polymeric fiber comprises polyester, nylon, aramid or cellulosic fibers.

10. The composite bearing of claim 7, wherein said polymeric fiber and polytetrafluoroethylene fibers are disposed within a resinous material.

11. The composite bearing claim 7, wherein said resinous material comprises a thermosetting polymer.

12. The composite bearing of claim 9, wherein said polymeric shell comprises a resinous material.

13. The composite bearing of claim 9, wherein said polymeric shell comprises a thermosetting polymer.

14. The composite bearing of claim 13, wherein said polymeric shell further comprises fiberglass.

15. A self-lubricating composite bearing comprising:
a shell comprising reinforced thermosetting resin having a surface thereon; and
a lining disposed on said surface of said shell, said lining comprising polytetrafluorethylene particles, a wetting agent, and a plurality of wound fibers disposed within a thermosetting matrix, wherein the plurality of fibers comprises polytetrafluoroethylene and at least one of polyester or nylon.

16. The self-lubricating composite bearing of claim 15, wherein the plurality of wound fibers are helically wound.

17. The self-lubricating composite bearing of claim 15, wherein the wetting agent comprises a non-ionic siloxane copolymer.

18. The self-lubricating composite bearing of claim 15, wherein 95% of the polytetrafluorethylene particles have a particle size of between 200 micro inches and 500 micro inches.

19. A method for manufacturing a composite bearing comprising:
disposing a plurality of fibers comprising polytetrafluoroethylene and second fiberous material onto a mandrel, said fibers being disposed in a thermosetting resin comprising polytetrafluoroethylene particles and a wetting agent; and
curing said thermosetting resin to form a rigid composite.

20. The method of claim 19, further comprising the step of removing said rigid composite from said mandrel.

21. The method of claim 19, wherein said disposing step comprises providing said plurality of fibers in the form of a helical winding.

22. The method of claim 19, wherein the thermosetting resin comprises an epoxy resin.

23. The method of claim 19 wherein said disposing step further comprises drawing said helical winding through a bath of epoxy resin comprising polytetrafluoroethylene particles and a wetting agent.

24. The composite bearing of claim 19, wherein 95% of the polytetrafluorethylene particles have a particle size of less than 500 micro inches.

25. The composite bearing of claim 19, wherein 95% of the polytetrafluorethylene particles have a particle size of greater than 200 micro inches.

26. The composite bearing of claim 19, wherein the polymer matrix comprises less than 15% by weight of polytetrafluoroethylene particles.

27. The composite bearing of claim 19, wherein the polymer matrix comprises greater than 1% by weight of polytetrafluoroethylene particles.
